(19) United States
(12) Patent Application Publication
(10) Pub. No.: US 2012/0072822 A1
(43) Pub. Date: Mar. 22, 2012

(54) DATA INTEGRATION

(75) Inventors: BRIAN R. BOKOR, RALEIGH, NC (US); HAN T. N. NGUYEN, APEX, NC (US); WILLIAM B. NICOL, II, DURHAM, NC (US); ANDREW B. SMITH, MORRISVILLE, NC (US)

(73) Assignee: INTERNATIONAL BUSINESS MACHINES CORPORATION, ARMONK, NY (US)

(21) Appl. No.: 12/884,339

(22) Filed: Sep. 17, 2010

(51) Int. Cl. G06F 17/00

(52) U.S. Cl. 715/230

(57) ABSTRACT

User data is integrated with services for management by the user. User selected data is annotated with a processor. The processor maps the annotated selected data to a user selected service provider. The annotated data is transmitted to a user selected service provider. The annotated user selected data is stored in a memory at the user selected service provider.

### BACKGROUND

The present invention relates in general to consolidating user information, and more particularly, to integrating consumer data with services for management by the user.

Cloud services in the consumer space provide new capabilities for integration and management of consumer data by the consumer. Services include, for example, the hosting of Personal Health Records (PHR) (Google Health™ from Google Inc., HealthVault™ from Microsoft, Inc., Dossia Personal Health Platform™ from Dossia, and WebMD® from WebMD, LLC), energy management sites, and Insurance services. Such services require service-to-service integration. An example of this can be found with integration to a hosted PHR application. PHR's may provide free hosted services for consumers and allow the user to link their profile to a partnering system that has implemented the appropriate APIs. Thus, a consumer's care network (personal physician, dentist, etc.) can send notifications to the consumer's hosted health profile. However, this requires the customer's care network, for example, his/her physician's computer system, has already done the service-to-service integration. Similarly when ad hoc information needs to be integrated into a service system, the end-user/consumer must enter this information manually.

### BRIEF SUMMARY

According to one embodiment of the present invention, a computer implemented method integrates user data with services for management by the user. The user selected data is annotated with a processor. The annotated selected data is mapped to a user selected service provider. The annotated data is transmitted to the user selected service provider. The annotated user selected data is stored in a memory at the user selected service provider.

According to one embodiment of the present invention, a computer program product integrates user data with services for management by the user. The computer program product comprises a computer readable storage medium having computer readable program code embodied therewith. The computer readable program code comprises computer readable program code configured to annotate the user selected data with a processor. Computer readable program code is configured to map, with a processor, the annotated selected data to a user selected service provider. Computer readable program code is configured to transmit the annotated data to the user selected service provider. Computer readable program code is configured to store, in a memory at the user selected service provider, the annotated user selected data.

A computer system integrates user data with services for management by the user. The computer system comprises a processor and a memory connected to the processor, wherein the memory is encoded with instructions and wherein the instructions when executed comprise instructions for annotating user selected data with a processor. Instructions map, with a processor, the annotated selected data to a user selected service provider. Instructions transmit the annotated data to the user selected service provider. Instructions store, in memory at the user selected service provider, the annotated user selected data.

### BRIEF DESCRIPTION OF THE SEVERAL VIEWS OF THE DRAWINGS

FIG. 1 is an illustration of a hardware arrangement that can implement an embodiment of the present invention;

FIG. 2 is an overview of an embodiment of the present invention;

FIG. 3 is illustrates the flow of an embodiment of the present invention;

FIG. 4 shows an example platform and annotation page for an embodiment of the present invention;

FIG. 5 illustrates details of the Annotation Manager for an embodiment of the present invention;

FIG. 6 is a flowchart of the updating of a cloud service for an embodiment of the present invention; and

FIG. 7 illustrates the use of multiple cloud services in accordance with an embodiment of the present invention;

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

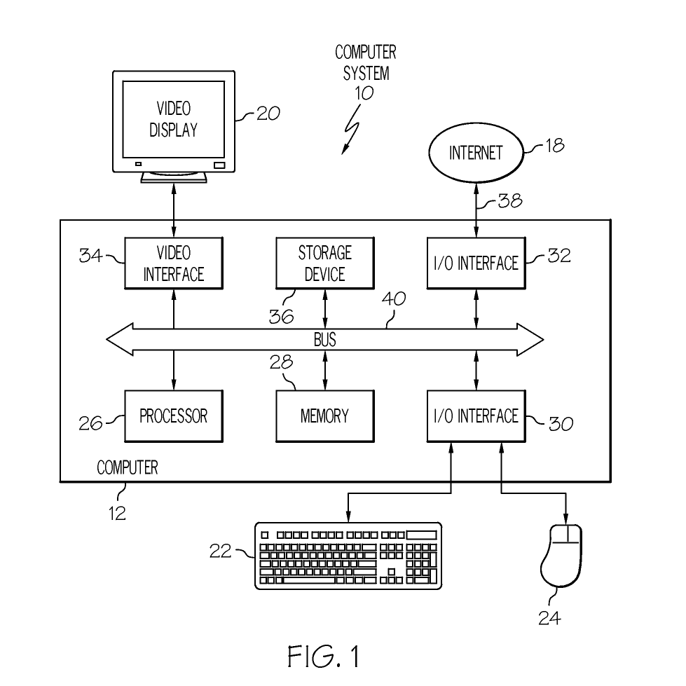

FIG. 1 is one example of a computer system 10 suitable for executing computer software for integrating consumer data with services for management by the user in accordance with the techniques described. Processing devices suitable for executing the software can be a mobile platform, including a wireless telephone, a personal assistant device (PDA), a portable computer, a smart remote control device, or any other processing devices that can execute such software.

The computer system 10 is of a type that executes under a suitable operating system installed on the computer system 10. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computers via an input/output (I/O) interface 32 using a communication channel 38 to a network, represented as the Internet 18. One or more servers 19 may be connected to the computer 12 via a network, such as, the Internet 18. The servers 19 may comprise the same physical arrangement as the computer 12 and may be co-located with or a part of the computer 12.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

End users or consumers using a cloud host may want to send their personal data to the host. As used herein, for the sake of continuity, the cloud host described will be for a Personal Health Record (PHR). The user's personal data may comprise, for example, recent medical diagnosis, prescription identification and dosage, shot records, etc. In one embodiment of the invention, an end user can annotate ad hoc or data outside of a particular service system used by service providers, thus, eliminating user entered data errors. The end users can specify the endpoints (user's cloud host of choice) to which the annotations should be posted, therefore, bridging any gaps between the service provider's system, client applications, and consumer storage (cloud host). This embodiment will enable provider services to reach more clients without incurring any cost of integrating with other services, and, therefore, lower the overall cost for consumers.

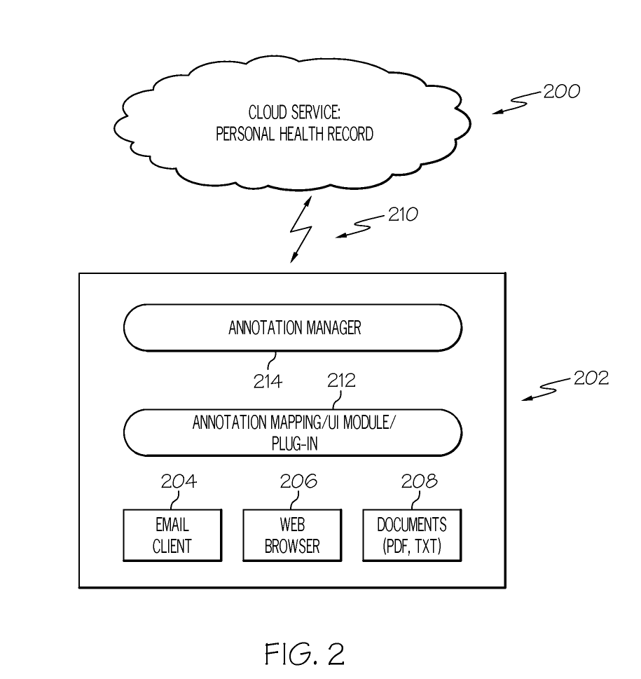

With reference now to FIG. 2, system components of one embodiment of the present invention are further illustrated. An end user integrates their personal health information onto a Personal Health Record (cloud service) 200 via a mobile platform (laptop computer, cell phone, PDA, etc.) 202. The Personal Health Record (PHR) 200 and the mobile platform 202 are interconnected by a wireless service, generally indicated by reference numeral 210. The mobile platform 202 includes an email client 204 and a web browser 206. Also provided on the platform 202 are a document (PDF, TXT) application 208, an Annotation Mapping/UI Module/Plug-in 212, and an Annotation Manager 214. The plug-in 212 provides the user interface that allows the user to interact with the annotation manager 214 and the PHR 200.

An example of one embodiment of the present invention will now be illustrated with reference to the following Scenario #1: A user has a medical issue while traveling and must go outside of his/her traditional health care network. An urgent care center the user visited does not have a system integrated with a host PHR but does provide email that details the visit for their clients. As a result, the end user will receive an email from the clinic that the present invention enables annotation thereto. The user can then directly interface the annotated email with his/her PHR service(s).

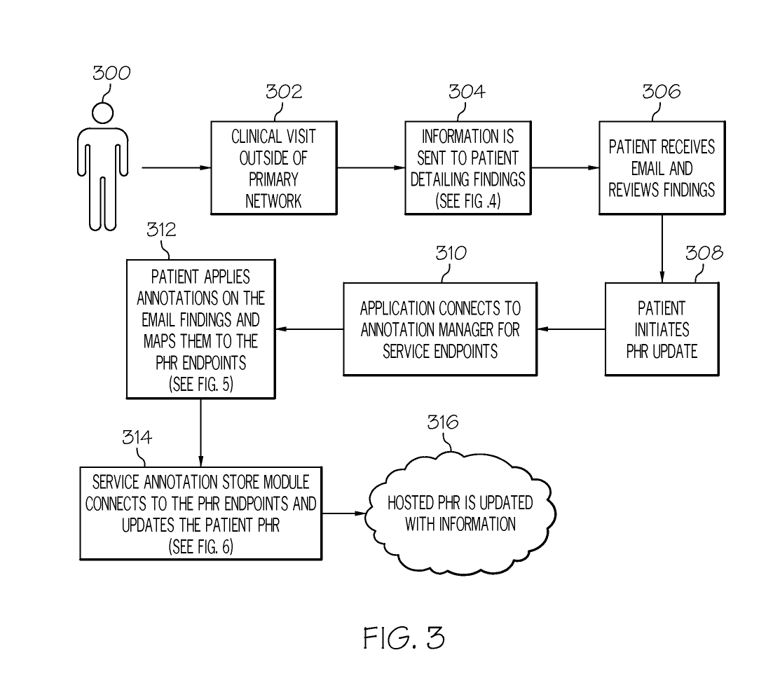

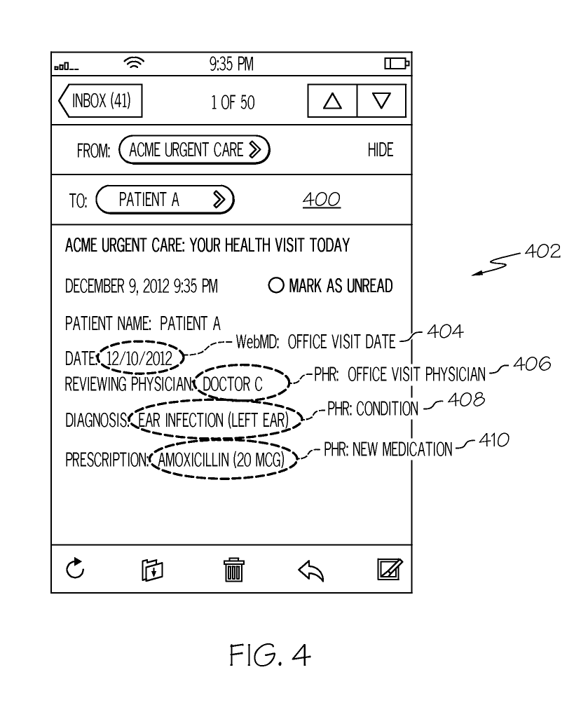

With reference to FIG. 3, an embodiment of the present invention under the circumstances of Scenario #1 is illustrated. A Patient (user) 300 was diagnosed with an ear infection at a care facility 302 that was out of his primary health care network. Information detailing the findings from the visit is sent to the user 300 via email at 304. One example of the information received from the clinic is shown in FIG. 4 as a screen display 400 on a mobile phone device 402. At 306, the user 300 receives the email and reviews the details of his condition and the treatment received.

After reviewing the email on, for example, the mobile phone device 402, the user initiates updates at 308 to the services of interest (user's PHR, user's primary care physician's PHR service, user's family members' mobile devices, etc.). At 310, the user interface of plug-in 212 (FIG. 2) connects to the Annotation Manager 214 via the user's mobile device and imports available annotations for the PHR 200 service (and any other services designated by the user) to the client's mobile platform 202.

At 312, the user 300 selects the information from the email to which he wants to apply annotations and maps them to the PHR 200 endpoints (and/or other services, as desired).

FIG. 4 illustrates selection and mapping of the information received via email. The user 300 has selected the Office Visit Date 404, the Office Visit Physician 406, the Condition 408, and the New Medication 410, all to be mapped to his PHR 200. Although not shown, it is to be understood that the user could annotate the email information in order to send the different details to multiple services.

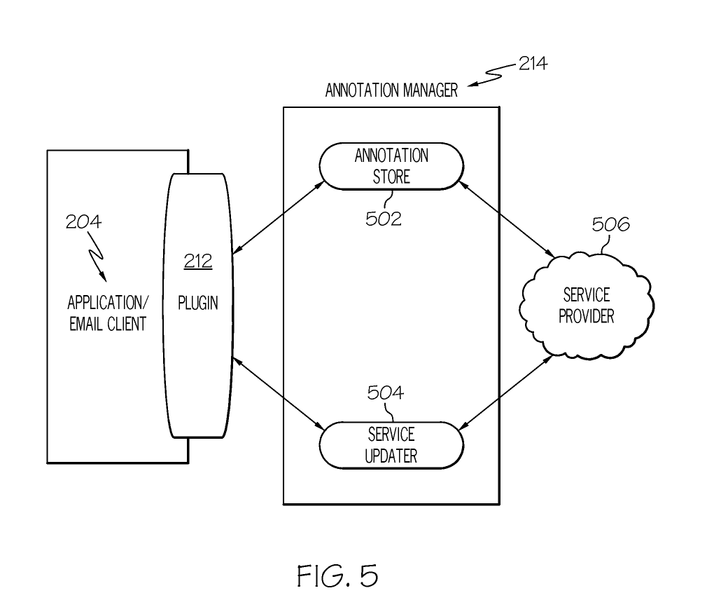

Referring to FIG. 5, further components of the Annotation Manager 214 of FIG. 2 are shown. A user interacts with the service provider 506, through an application, such as the email client 204. All messages from the client 204 pass through the plug-in 21, as previously described. From the plug-in 212, a message goes through the Annotation Manager 214. Within the Manager 214, there is also an Annotation Store 502 and a Service Updater 504.

The Annotation Store 502 connects to the endpoints specified by the user to which the annotations will be posted. The Annotation Store 502 ensures that the annotations are supported by a Service Provider 506, such as the PHR 200, sends annotation requests to the Service Provider 506, and communicates the response back to the user based on each annotation request. The Service Updater 504 sends requests to the Service Provider 506 mapped by an annotation and updates the Service Provider 506. Thus, the Service Updater 504 leverages the applied annotations and retrieves the highlighted text. It then maps the input based on the annotation association and maps the corresponding values to the appropriate hosted Service Provider 506.

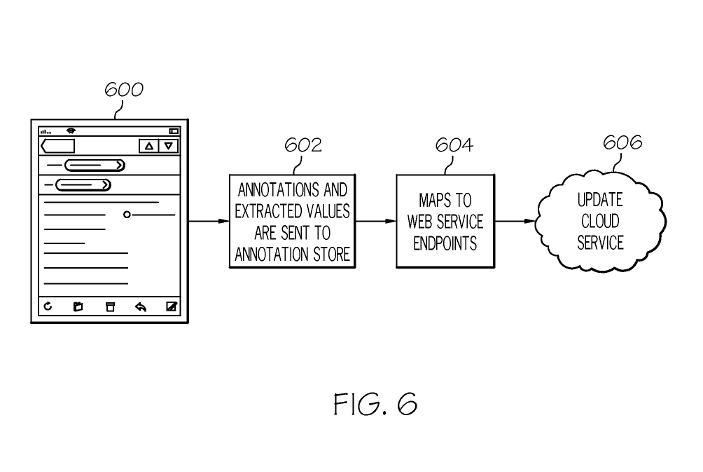

Returning to FIG. 3, at 314, the Annotation Store 502 (FIG. 5) connects to the selected endpoints and updates the PHR 200. Referring to FIG. 6, the actions at block 314 are illustrated in greater detail. The user annotates the desired material at 600, as shown in FIG. 4. At block 602, annotations and extracted values are sent to the Annotation Store 502. At block 604, the Annotation Store Module maps to the user selected endpoints and the selected services are updated at 606. Thus, the hosted PHR 200 is updated with the information received in an email from the care facility outside the user's normal health care network. As a result, the user 300 has quickly updated his PHR 200 without any transcription errors.

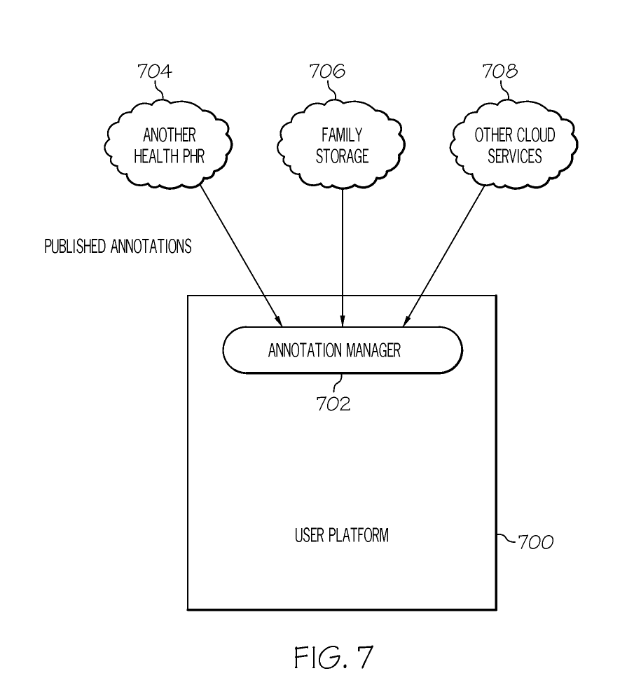

Referring now to FIG. 7, an embodiment of the present invention comprises updating to a plurality of service providers. The user platform 700 includes the same modules as the mobile platform 202 of FIG. 2, however, for the sake of brevity, only the Annotation Manager 702 is illustrated. As shown, the Annotation Manager 702 is interconnected to three cloud services, Another Health PHR 704, Family Storage 706, and Other Cloud Services 708. The user can select as many cloud services as desired using the published annotations from each service.

Scenario #2: A consumer visited a car dealer and was interested in purchasing a car. To help the consumer make purchase decision, the car dealer agent sent the car specification to the consumer's email for further research. The consumer then used the data to inquire and compare car insurance quotes from different services. Using the annotation manager of one embodiment of the present invention, the consumer initiated insurance quote inquiries to get the annotations from various insurance services, applied annotations for the car's specification and mapped to the endpoints of the service interfaces. The Service Updater 504 would then post the consumer's requests to the specified service interfaces to obtain the insurance quotes for the consumer

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method for integrating user data with services for management by the user, comprising:
annotating user selected data with a processor;
mapping, with a processor, said annotated selected data to a user selected service provider;
transmitting said annotated data to said user selected service provider; and
storing, in a memory at said user selected service provider, said annotated user selected data.

2. The computer implemented method of claim 1, further comprising receiving un-annotated data in an email from a third party, on a user selected platform.

3. The computer implemented method of claim 2, wherein mapping, with a processor, said annotated data to a user selected service provider further comprises negotiating updates to said user selected data between said service provider and said user selected platform.

4. The computer implemented method of claim 3, wherein said negotiating comprises sending said annotated data with an annotation manager.

5. The computer implemented method of claim 4, wherein said annotation manager further comprises an annotation store for connecting to said user selected service provider.

6. The computer implemented method of claim 4, wherein said annotation manager further comprises a service updater for sending said user selected data to said user selected service provider.

7. The computer implemented method of claim 1, wherein said mapping, with a processor, said annotated selected data further comprises selecting a plurality of user selected service providers.

8. A computer program product for integrating user data with services for management by the user, the computer program product comprising a computer readable storage medium having computer readable program code embodied therewith, the computer readable program code comprising:
computer readable program code configured to annotate user selected data with a processor;
computer readable program code configured to map, with a processor, said annotated selected data to a user selected service provider;
computer readable program code configured to transmit said annotated data to said user selected service provider; and
computer readable program code configured to store, in a memory at said user selected service provider, said annotated user selected data.

9. The computer program product of claim 8, further comprising computer readable program code configured to receive, un-annotated data in an email from a third party, on a user selected platform.

10. The computer program product of claim 9, wherein mapping, with a processor, said annotated data to a user selected service provider further comprises computer readable program code configured to negotiate updates to said user selected data between said service provider and said user selected platform.

11. The computer program product of claim 10, wherein said negotiating comprises computer readable program code configured to send said annotated data with an annotation manager.

12. The computer program product of claim 11, wherein said annotation manager further comprises an annotation store for connecting to said user selected service provider.

13. The computer program product of claim 11, wherein said annotation manager further comprises a service updater for sending said user selected data to said user selected service provider.

14. The computer program product of claim 8, wherein said mapping, with a processor, said annotated selected data further comprises computer readable program code configured to select a plurality of user selected service providers.

15. A computer system for integrating user data with services for management by the user, comprising:
a processor; and
memory connected to the processor, wherein the memory is encoded with instructions and wherein the instructions when executed comprise:
instructions for annotating user selected data with a processor;
instructions for mapping, with a processor, said annotated selected data to a user selected service provider;
instructions for transmitting said annotated data to said user selected service provider; and
instructions for storing, in memory at said user selected service provider, said annotated user selected data.

16. The computer system of claim 15, further comprising instructions for receiving un-annotated data in an email from a third party, on a user selected platform.

17. The computer system of claim 16, wherein mapping, with a processor, said annotated data to a user selected service provider further comprises instructions for negotiating updates to said user selected data between said service provider and said user selected platform.

18. The computer system of claim 17, wherein said instructions for negotiating comprises instructions for sending said annotated data with an annotation manager.

19. The computer system of claim 18, wherein said annotation manager further comprises an annotation store for connecting to said user selected service provider.

20. The computer system of claim 18, wherein said annotation manager further comprises a service updater for sending said user selected data to said user selected service provider.
